(19) United States
(12) Patent Application Publication
(10) Pub. No.: US 2024/0050831 A1
(43) Pub. Date: Feb. 15, 2024

(54) INSTRUCTOR AVATARS FOR AUGMENTED REALITY EXPERIENCES

(71) Applicants: Ilteris Canberk, Marina Del Rey, CA (US); Ivan Fekete, Odessa (UA); Shin Hwun Kang, Los Angeles, CA (US); Dmytro Kucher, Odessa (UA); Ihor Kuzin, Kyiv (UA); Vernon James Carlos Manlapaz, Glendale, CA (US); Artur Sydoran, Uzhhorod (UA)

(72) Inventors: Ilteris Canberk, Marina Del Rey, CA (US); Ivan Fekete, Odessa (UA); Shin Hwun Kang, Los Angeles, CA (US); Dmytro Kucher, Odessa (UA); Ihor Kuzin, Kyiv (UA); Vernon James Carlos Manlapaz, Glendale, CA (US); Artur Sydoran, Uzhhorod (UA)

(21) Appl. No.: 17/957,141

(22) Filed: Sep. 30, 2022

Related U.S. Application Data
(60) Provisional application No. 63/396,643, filed on Aug. 10, 2022.

(51) Int. Cl. A63B 71/06; G06T 13/40; G06T 7/70; G06F 3/01; G06F 3/16; G06T 13/80; A63B 24/00; G10L 15/22

(52) U.S. Cl. CPC A63B 71/0622; G06T 13/40; G06T 7/70; G06F 3/012; G06F 3/167; G06T 13/80; A63B 24/0075; G10L 15/22; G06T 2207/30244; G06T 2207/30196; G06T 2207/10016; A63B 2071/0636; A63B 2220/803; A63B 2220/05; A63B 2220/806; A63B 2071/065; G10L 2015/223

(57) ABSTRACT

An application enables users of electronic eyewear devices to bring a workout session anywhere and have aspects of the workout session (e.g., number of repetitions) recorded automatically. It also allows users to have always-on visibility of their workout instructor so that they can, for example, continue to maintain a visual guide for their form/pose. Virtual avatars perform demonstrations about activities such as yoga in an augmented reality environment using the display of an electronic eyewear device. The demonstration elements can be controlled using voice commands.

### CROSS-REFERENCE TO RELATED APPLICATIONS

This application claims priority to U.S. Application Ser. No. 63/396,643 filed on Aug. 10, 2022, the contents of which are incorporated fully herein by reference.

### TECHNICAL FIELD

Examples set forth in the present disclosure relate to the field of augmented reality (AR) experiences for electronic devices, including wearable devices such as eyewear. More particularly, but not by way of limitation, the present disclosure describes the presentation of virtual avatars using electronic eyewear devices that deliver AR tutorials and demonstrations, e.g., for posture-specific activities like yoga.

### BACKGROUND

Many types of computers and electronic devices available today, such as mobile devices (e.g., smartphones, tablets, and laptops), handheld devices, and wearable devices (e.g., smart glasses, digital eyewear, headwear, headgear, and head-mounted displays), include a variety of cameras, sensors, wireless transceivers, input systems, and displays. Users sometimes refer to information on these devices during physical activities such as exercise.

Virtual reality (VR) technology generates a complete virtual environment including realistic images, sometimes presented on a VR headset or other head-mounted display. VR experiences allow a user to move through the virtual environment and interact with virtual objects. AR is a type of VR technology that combines real objects in a physical environment with virtual objects and displays the combination to a user. The combined display gives the impression that the virtual objects are authentically present in the environment, especially when the virtual objects appear and behave like the real objects. Cross reality (XR) is generally understood as an umbrella term referring to systems that include or combine elements from AR, VR, and MR (mixed reality) environments.

Automatic speech recognition (ASR) is a field of computer science, artificial intelligence, and linguistics which involves receiving spoken words and converting the spoken words into audio data suitable for processing by a computing device. Processed frames of audio data can be used to translate the received spoken words into text or to convert the spoken words into commands for controlling and interacting with various software applications. ASR processing may be used by computers, handheld devices, wearable devices, telephone systems, automobiles, and a wide variety of other devices to facilitate human-computer interactions.

### BRIEF DESCRIPTION OF THE DRAWINGS

Features of the various examples described will be readily understood from the following detailed description, in which reference is made to the figures. A reference numeral is used with each element in the description and throughout the several views of the drawing. When a plurality of similar elements is present, a single reference numeral may be assigned to like elements, with an added upper or lower-case letter referring to a specific element.

The various elements shown in the figures are not drawn to scale unless otherwise indicated. The dimensions of the various elements may be enlarged or reduced in the interest of clarity. The several figures depict one or more implementations and are presented by way of example only and should not be construed as limiting. Included in the drawing are the following figures:

FIG. 1A is a side view (right) of an electronic eyewear device suitable for use in an example virtual guided fitness system;

FIG. 1B is a perspective, partly sectional view of optical components and electronics in a portion of the electronic eyewear device illustrated in FIG. 1A;

FIG. 1C is a side view (left) of the electronic eyewear device of FIG. 1A;

FIG. 1D is a perspective, partly sectional view of optical components and electronics in a portion of the electronic eyewear device illustrated in FIG. 1C;

FIGS. 2A and 2B are rear views of an electronic eyewear device utilized in an example virtual guided fitness system;

FIG. 3 is a block diagram illustrating an example of capturing visible light using an example electronic eyewear device illustrated in any of the proceeding figures;

FIG. 4 is a functional block diagram of an example demonstration system including an electronic eyewear device and a server system connected via various networks;

FIG. 5 is a diagrammatic representation of an example hardware configuration for a mobile device configured for use in the example demonstration system of FIG. 4;

FIG. 6 is a perspective view of a user in an example environment for use in describing an example object tracking algorithm known as Simultaneous Localization and Mapping (SLAM);

FIG. 7A is a perspective illustration of an example virtual exercise tutorial, including a primary avatar, presented on a display;

FIG. 7B is a perspective view of an example virtual exercise tutorial, including a primary avatar presented on a display, along with a live instructor;

FIG. 7C is a perspective view of an example virtual exercise tutorial, including a secondary avatar, presented on a display; and

FIG. 8 is a flow chart listing the steps in an example method of presenting a virtual exercise tutorial on a display.

### DETAILED DESCRIPTION

An application enables users of electronic eyewear devices to bring workout sessions anywhere and have aspects of the workout sessions (e.g., proper form, number of repetitions) recorded automatically. It also allows users to have always-on visibility of their workout instructor so that they can, for example, continue to maintain a visual guide for their form/pose.

Various implementations and details are described with reference to examples for presenting a virtual exercise tutorial in an augmented reality environment. In an example implementation, a method includes presenting a primary avatar on a display of a wearable device at a fixed position relative to the physical environment, such as the place where a live instructor might stand to lead a group activity or class. Many activities like yoga, calisthenics, gymnastics, and dance involve changes in body posture (e.g., head pose, gaze direction), which make it difficult for a student to watch the primary avatar (or a live instructor). In another example implementation, the method includes presenting a secondary avatar on the display which is persistently viewable from any posture. The primary and secondary avatars are correlated to provide the same or similar demonstrations and tutorial content.

Another example implementation includes presenting a primary avatar at an instructor position on the display of an electronic eyewear device, capturing motion data with an inertial measurement unit (IMU), and estimating an electronic eyewear device location relative to the instructor position based on the motion data. Based on the estimated electronic eyewear device location, the method includes presenting a secondary avatar at a frame position relative to the display.

Another example implementation includes selectively presenting the secondary avatar based on the primary avatar's instructor position relative to the field of view of a camera coupled to the electronic eyewear device. In this example, the secondary avatar is presented when the electronic eyewear device location or the camera suggests the primary avatar is outside the field of view of the camera.

Another example implementation includes animating one or both avatars to perform a demonstration associated with an exercise activity. The demonstration elements include one or more poses, each associated with a pose lesson and a pose duration. This example method includes retrieving and controlling the demonstration elements using voice recognition.

Although the various systems and methods are described herein with reference to yoga, the technology described herein may be applied to essentially any type of motion or activity in which proper posture is desired. For example, proper posture is a desired feature of exercise activities like yoga, Pilates, calisthenics, isometrics, aerobics, weightlifting, swimming, and running. Proper posture is also desired for activities such as golf, martial arts, gymnastics, diving, physical therapy, ballet, and dance. Moreover, the technology described herein may be applied to any type of motion or activity that involves changes in body posture (e.g., especially changes in head pose and gaze direction) which make it difficult for a student to see a live instructor or other resource.

The following detailed description includes systems, methods, techniques, instruction sequences, and computer program products illustrative of examples set forth in the disclosure. Numerous details and examples are included for the purpose of providing a thorough understanding of the disclosed subject matter and its relevant teachings. Those skilled in the relevant art, however, may understand how to apply the relevant teachings without such details. Aspects of the disclosed subject matter are not limited to the specific devices, systems, and methods described because the relevant teachings can be applied or practiced in a variety of ways. The terminology and nomenclature used herein is for the purpose of describing particular aspects only and is not intended to be limiting. In general, well-known instruction instances, protocols, structures, and techniques are not necessarily shown in detail.

The term “connect,” “connected,” “couple,” and “coupled” as used herein refers to any logical, optical, physical, or electrical connection, including a link or the like by which the electrical or magnetic signals produced or supplied by one system element are imparted to another coupled or connected system element. Unless described otherwise, coupled, or connected elements or devices are not necessarily directly connected to one another and may be separated by intermediate components, elements, or communication media, one or more of which may modify, manipulate, or carry the electrical signals. The term “on” means directly supported by an element or indirectly supported by the element through another element integrated into or supported by the element.

The term “proximal” is used to describe an item or part of an item that is situated near, adjacent, or next to an object or person; or that is closer relative to other parts of the item, which may be described as “distal.” For example, the end of an item nearest an object may be referred to as the proximal end, whereas the generally opposing end may be referred to as the distal end.

The orientations of the electronic eyewear device, associated components and any complete devices incorporating an eye scanner and camera such as shown in any of the drawings, are given by way of example only, for illustration and discussion purposes. In operation for a particular variable optical processing application, the electronic eyewear device may be oriented in any other direction suitable to the particular application of the electronic eyewear device, for example up, down, sideways, or any other orientation. Also, to the extent used herein, any directional term, such as front, rear, inwards, outwards, towards, left, right, lateral, longitudinal, up, down, upper, lower, top, bottom and side, are used by way of example only, and are not limiting as to direction or orientation of any optic or component of an optic constructed as otherwise described herein.

Advanced AR technologies, such as computer vision and object tracking, may be used to produce a perceptually enriched and immersive experience. Computer vision algorithms extract three-dimensional data about the physical world from the data captured in digital images or video. Object recognition and tracking algorithms are used to detect an object in a digital image or video, estimate its orientation or pose, and track its movement over time. Hand and finger recognition and tracking in real time is a challenging and processing-intensive tasks in the field of computer vision.

In the context of computer vision, object recognition, and tracking, the term “pose” refers to the static position and orientation of an object at a particular instant in time. The term “gesture” refers to the active movement of an object, such as a hand, through a series of poses, sometimes to convey a signal or idea. The terms, pose and gesture, are sometimes used interchangeably in the field of computer vision and augmented reality. As used herein, the terms “pose” or “gesture” (or variations thereof) are intended to be inclusive of both poses and gestures; in other words, the use of one term does not exclude the other.

Additional objects, advantages and novel features of the examples will be set forth in part in the following description, and in part will become apparent to those skilled in the art upon examination of the following and the accompanying drawings or may be learned by production or operation of the examples. The objects and advantages of the present subject matter may be realized and attained by means of the methodologies, instrumentalities and combinations particularly pointed out in the appended claims.

In sample configurations, electronic eyewear devices with augmented reality (AR) capability are used in the systems described herein. Electronic eyewear devices are desirable to use in the system described herein as such devices are scalable, customizable to enable personalized experiences, enable effects to be applied anytime, anywhere, and ensure user privacy by enabling only the user to see the transmitted information. An electronic eyewear device such as SPECTACLES™ available from Snap, Inc. of Santa Monica, California, may be used without any specialized hardware in a sample configuration.

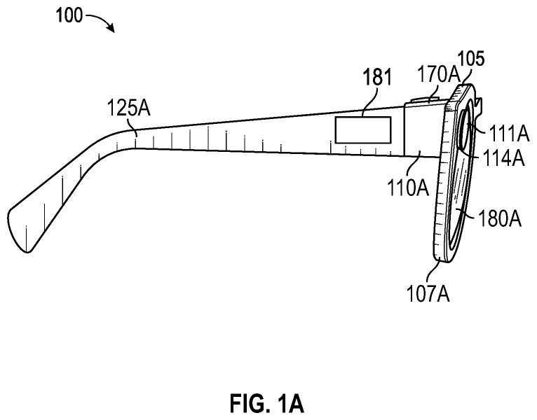

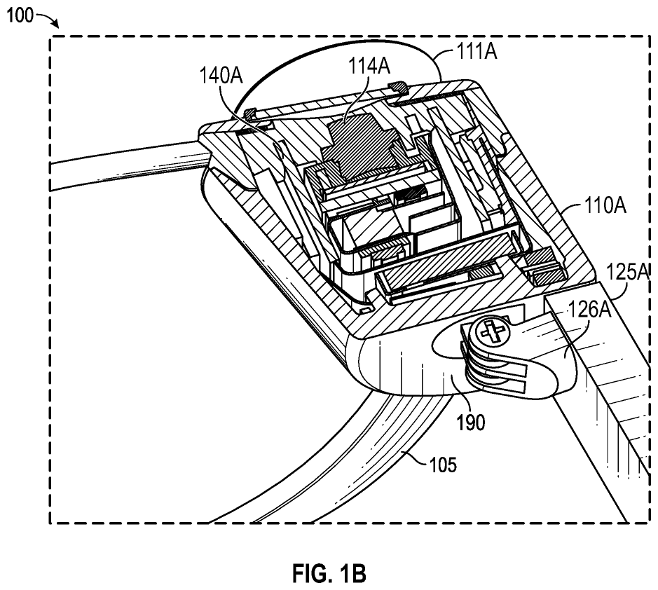

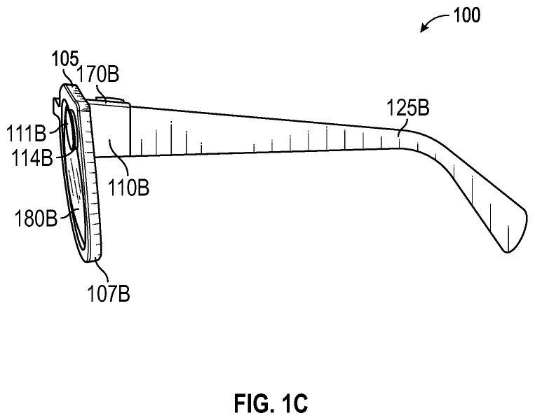

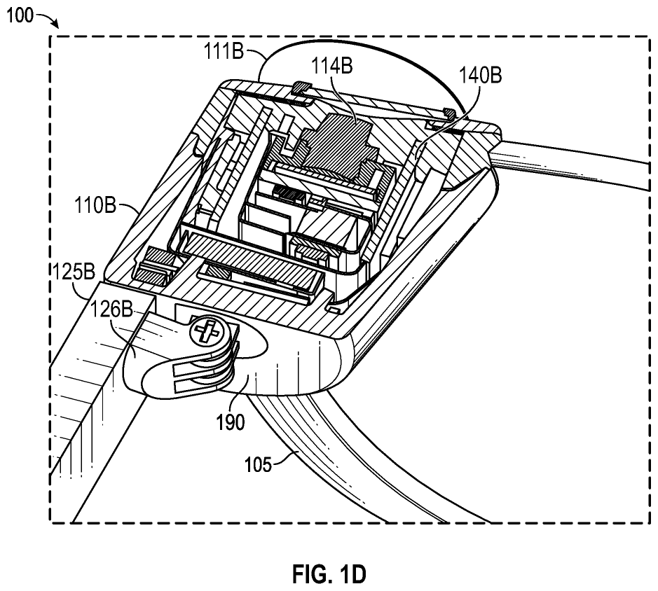

As shown in FIGS. 1A-1D, the electronic eyewear device 100 includes a first camera 114A and a second camera 114B. The cameras 114 capture image information for a scene from separate viewpoints. The captured images may be used to project a three-dimensional display onto an image display for three dimensional (3D) viewing.

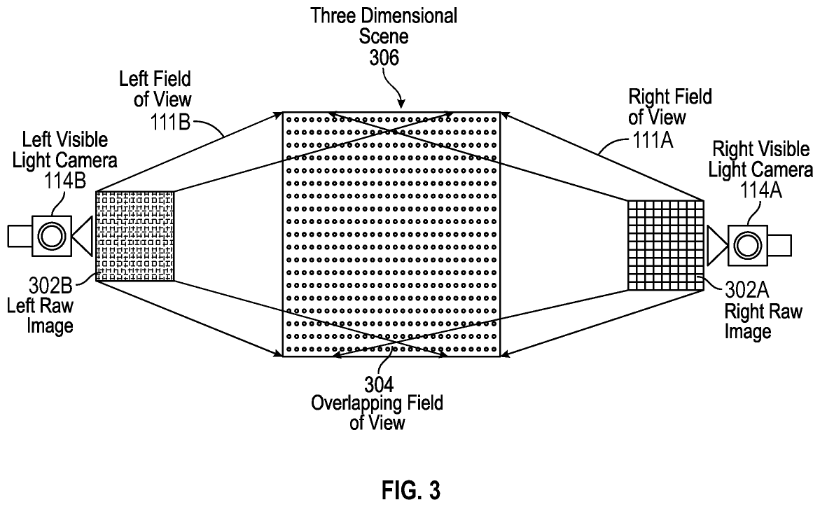

The cameras 114 are sensitive to the visible-light range wavelength. Each of the cameras 114 define a different frontward facing field of view, which are overlapping to enable generation of 3D depth images; for example, a first camera 114A defines a first field of view 111A and a second camera 114B defines a second field of view 114B. Generally, a “field of view” is the part of the scene that is visible through the camera at a particular position and orientation in space. The fields of view 111 have an overlapping field of view 304 (FIG. 3). Objects or object features outside the field of view 111 when the camera captures the image are not recorded in a raw image (e.g., photograph or picture). The field of view describes an angle range or extent, which the image sensor of the camera 114 picks up electromagnetic radiation of a given scene in a captured image of the given scene. Field of view can be expressed as the angular size of the view cone; i.e., an angle of view. The angle of view can be measured horizontally, vertically, or diagonally.

In an example configuration, one or both cameras 114 has a field of view of 100° and a resolution of 480×480 pixels. The “angle of coverage” describes the angle range that a lens of the cameras 114 can effectively image. Typically, the camera lens produces an image circle that is large enough to cover the film or sensor of the camera completely, possibly including some vignetting (e.g., a darkening of the image toward the edges when compared to the center). If the angle of coverage of the camera lens does not fill the sensor, the image circle will be visible, typically with strong vignetting toward the edge, and the effective angle of view will be limited to the angle of coverage.

Examples of suitable cameras 114 include a high-resolution complementary metal-oxide-semiconductor (CMOS) image sensor and a digital VGA camera (video graphics array) capable of resolutions of 480p (e.g., 640×480 pixels), 720p, 1080p, or greater. Other examples include cameras 114 that can capture high-definition (HD) video at a high frame rate (e.g., thirty to sixty frames per second, or more) and store the recording at a resolution of 1216 by 1216 pixels (or greater).

The electronic eyewear device 100 may capture image sensor data from the cameras 114 along with geolocation data, digitized by an image processor, for storage in a memory. The cameras 114 capture respective raw images (e.g., left and right raw images) in the two-dimensional space domain that comprise a matrix of pixels on a two-dimensional coordinate system that includes an X-axis for horizontal position and a Y-axis for vertical position. Each pixel includes a color attribute value (e.g., a red pixel light value, a green pixel light value, or a blue pixel light value); and a position attribute (e.g., an X-axis coordinate and a Y-axis coordinate).

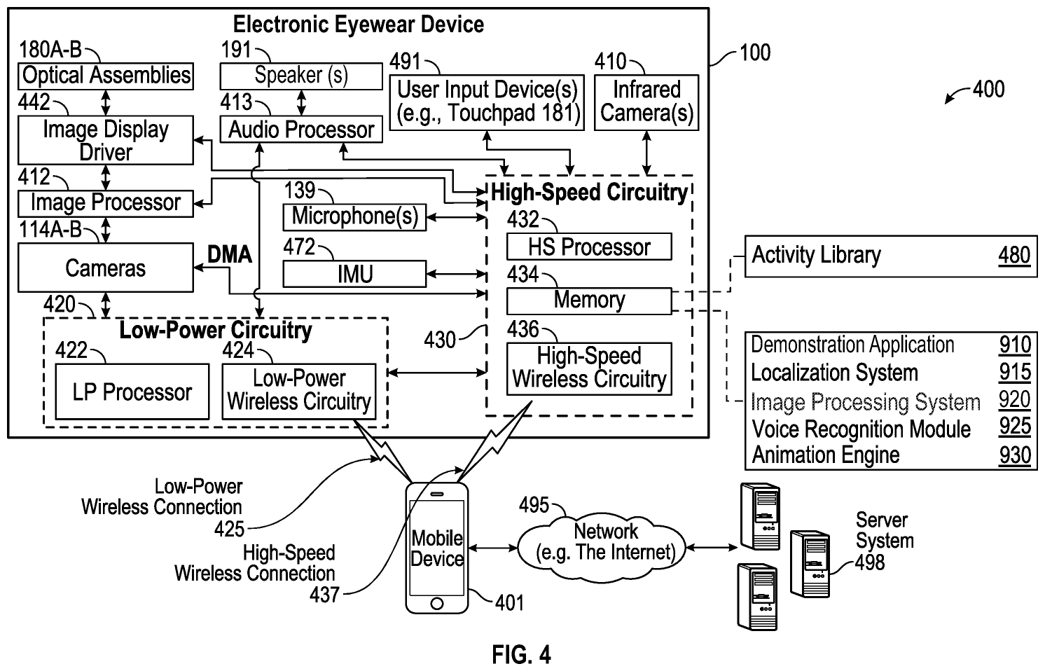

In order to capture stereo images for later display as a 3D projection, the image processor 412 (FIG. 4) may be coupled to the cameras 114 to receive and store the visual image information. The image processor 412, or another processor, controls operation of the cameras 114 to act as a stereo camera simulating human binocular vision and may add a timestamp to each image. The timestamp on each pair of images allows display of the images together as part of a 3D projection. 3D projections produce an immersive, life-like experience that is desirable in a variety of contexts, including virtual reality (VR) and video gaming.

FIG. 1B is a perspective, cross-sectional view of a right corner 110A of the electronic eyewear device 100 of FIG. 1A depicting the first camera 114A, additional optical components, and electronics. FIG. 1C is a side view (left) of an example hardware configuration of an electronic eyewear device 100 of FIG. 1A, which shows the second camera 114B of the camera system. FIG. 1D is a perspective, cross-sectional view of a left corner 110B of the electronic eyewear device 100 of FIG. 1C depicting the second camera 114B of the camera system, additional optical components, and electronics.

As shown in the example of FIG. 1B, the electronic eyewear device 100 includes the first camera 114A and a circuit board 140A, which may be a flexible printed circuit board (PCB). A first hinge 126A connects the right corner 110A to a first temple 125A of the electronic eyewear device 100. In some examples, components of the first camera 114A, the flexible PCB 140A, or other electrical connectors or contacts may be located on the first temple 125A or the first hinge 126A.

The right corner 110A includes corner body 190 and a corner cap, with the corner cap omitted in the cross-section of FIG. 1B. Disposed inside the right corner 110A are various interconnected circuit boards, such as the flexible PCB 140A, that include controller circuits for the first camera 114A, microphone(s) 139, speaker(s) 191, low-power wireless circuitry (e.g., for wireless short range network communication via Bluetooth™), high-speed wireless circuitry (e.g., for wireless local area network communication via Wi-Fi).

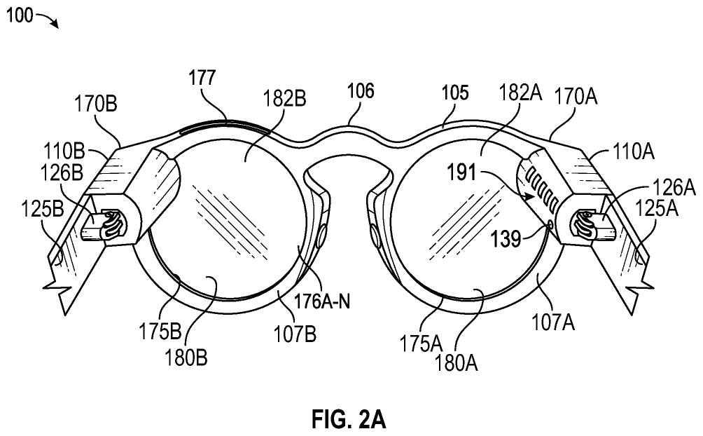

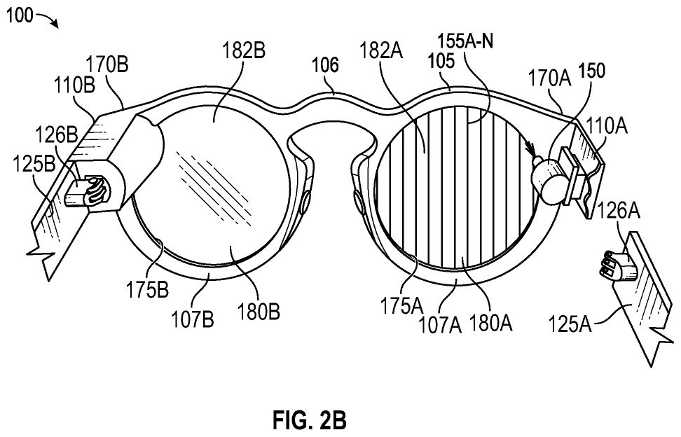

The first camera 114A is coupled to or disposed on the flexible PCB 140A and is covered by a camera cover lens, which is aimed through opening(s) formed in the frame 105. For example, the right rim 107A of the frame 105, shown in FIG. 2A, is connected to the right corner 110A and includes the opening(s) for the camera cover lens. The frame 105 includes a front side configured to face outward and away from the eye of the user. The opening for the camera cover lens is formed on and through the front or outward-facing side of the frame 105. In the example, the first camera 114A has an outward-facing field of view 111A (shown in FIG. 3) with a line of sight or perspective that is correlated with the right eye of the user of the electronic eyewear device 100. The camera cover lens can also be adhered to a front side or outward-facing surface of the right corner 110A in which an opening is formed with an outward-facing angle of coverage, but in a different outwardly direction. The coupling can also be indirect via intervening components.

As shown in the example of FIG. 1D, the electronic eyewear device 100 includes the second camera 114B and a circuit board 140B, which may be a flexible printed circuit board (PCB). A second hinge 126B connects the left corner 110B to a second temple 125B of the electronic eyewear device 100. In some examples, components of the second camera 114B, the flexible PCB 140B, or other electrical connectors or contacts may be located on the second temple 125B or the second hinge 126B.

The left corner 110B includes corner body 190 and a corner cap, with the corner cap omitted in the cross-section of FIG. 1D. Disposed inside the right corner 110A are various interconnected circuit boards, such as the flexible PCB 140B, that include controller circuits for the second camera 114B.

The camera 114 are coupled to or disposed on respective flexible PCBs 140 and are covered by a camera cover lens, which is aimed through opening(s) formed in the frame 105. For example, as shown in FIG. 2A, the right rim 107A of the frame 105 is connected to the right corner 110A and includes the opening(s) for the camera cover lens and the left rim 107B of the frame 105 is connected to the left corner 110B and includes the opening(s) for the camera cover lens. The frame 105 includes a front side configured to face outward and away from the eye of the user. The opening for the camera cover lens is formed on and through the front or outward-facing side of the frame 105. In the example, the cameras 114 have respective outward-facing fields of view 111 (shown in FIG. 3) with a line of sight or perspective that is correlated with a respective eye of the user of the electronic eyewear device 100. The camera cover lenses can also be adhered to a front side or outward-facing surface of the respective corners 110 in which an opening is formed with an outward-facing angle of coverage, but in a different outwardly direction. The coupling can also be indirect via intervening components.

FIGS. 2A and 2B depict example hardware configurations of the electronic eyewear device 100, including two different types of image displays. The electronic eyewear device 100 is sized and shaped in a form configured for wearing by a user. The form of eyeglasses is shown in the illustrated examples. The electronic eyewear device 100 can take other forms and may incorporate other types of frameworks; for example, a headgear, a headset, or a helmet.

In the eyeglasses example, electronic eyewear device 100 includes a frame 105 including a right rim 107A connected to a left rim 107B via a bridge 106 configured to receive a nose of the user to support the electronic eyewear device 100 on the user's head. The right rim 107A include a first apertures 175A, which hold a first optical element 180, such as a lens and a display device. The left rim 107B include a second apertures 175B, which hold a second optical element 180B, such as a lens and a display device. As used herein, the term “lens” is meant to include transparent or translucent pieces of glass or plastic having curved or flat surfaces that cause light to converge or diverge or that cause little or no convergence or divergence.

A touch-sensitive input device, such as a touchpad 181 is positioned on the first temple 125A. As shown, the touchpad 181 may have a boundary that is plainly visible or includes a raised or otherwise tactile edge that provides feedback to the user about the location and boundary of the touchpad 181; alternatively, the boundary may be subtle and not easily seen or felt. The electronic eyewear device 100 may include a touchpad on the other side that operates independently or in conjunction with the touchpad 181.

The surface of the touchpad 181 is configured to detect finger touches, taps, and gestures (e.g., moving touches) for use with a graphical user interface (GUI) displayed by the electronic eyewear device, on an image display, to allow the user to navigate through and select menu options in an intuitive manner, which enhances and simplifies the user experience.

Detection of finger inputs on the touchpad 181 can enable several functions. For example, touching anywhere on the touchpad 181 may cause the GUI to display or highlight an item on the image display, which may be projected onto at least one of the optical assemblies 180. Tapping or double tapping on the touchpad 181 may select an item or icon. Sliding or swiping a finger in a particular direction (e.g., from front to back, back to front, up to down, or down to) may cause the items or icons to slide or scroll in a particular direction; for example, to move to a next item, icon, video, image, page, or slide. Sliding the finger in another direction may slide or scroll in the opposite direction; for example, to move to a previous item, icon, video, image, page, or slide. The touchpad 181 can be positioned essentially anywhere on the electronic eyewear device 100.

In one example, an identified finger gesture of a single tap on the touchpad 181, initiates selection or pressing of a GUI element in the image presented on the image display of the optical assembly 180. An adjustment to the image presented on the image display of the optical assembly 180 based on the identified finger gesture can be a primary action which selects or submits the GUI element on the image display of the optical assembly 180 for further display or execution.

FIG. 2A is an example hardware configuration for the electronic eyewear device 100 in which the right corner 110A supports a microphone 139 and a speaker 191. The microphone 139 includes a transducer that converts sound into a corresponding electrical audio signal. The microphone 139 in the illustrated example is positioned with an opening that faces inward toward the wearer, to facilitate reception of the sound waves, such as human speech including verbal commands and questions. Additional or differently oriented openings may be implemented. In other example configurations, the electronic eyewear device 100 is coupled to one or more microphones 139, configured to operate together or independently, and positioned at various locations on the electronic eyewear device 100.

The speaker 191 includes an electro-acoustic transducer that converts an electrical audio signal into a corresponding sound. The speaker 191 is controlled by one of the processors 422, 432 or by an audio processor 413 (FIG. 4). The speaker 191 in this example includes a series of oblong apertures, as shown, that face inward to direct the sound toward the wearer. Additional or differently oriented apertures may be implemented. In other example configurations, the electronic eyewear device 100 is coupled to one or more speakers 191, configured to operate together (e.g., in stereo, in zones to generate surround sound) or independently, and positioned at various locations on the electronic eyewear device 100. For example, one or more speakers 191 may be incorporated into the frame 105, temples 125, or corners 110 of the electronic eyewear device 100.

Although shown in FIG. 2A and FIG. 2B as having two optical elements 180, the electronic eyewear device 100 can include other arrangements, such as a single optical element (or it may not include any optical element 180), depending on the application or the intended user of the electronic eyewear device 100. As further shown, electronic eyewear device 100 includes a right corner 110A adjacent the right lateral side 170A of the frame 105 and a left corner 110B adjacent the left lateral side 170B of the frame 105. The corners 110 may be integrated into the frame 105 on the respective sides 170 (as illustrated) or implemented as separate components attached to the frame 105 on the respective sides 170. Alternatively, the corners 110A, 110B may be integrated into temples (not shown) attached to the frame 105.

In one example, each image display of optical assembly 180 includes an integrated image display (e.g., a first display 182A and a second display 182B). As shown in FIG. 2A, each optical assembly 180 has a display 182 that includes a suitable display matrix 177, such as a liquid crystal display (LCD), an organic light-emitting diode (OLED) display, or other such display. Each optical assembly 180 also includes an optical layer or layers 176, which can include lenses, optical coatings, prisms, mirrors, waveguides, optical strips, and other optical components in any combination. The optical layers (shown as 176A-N in FIG. 2A) can include a prism having a suitable size and configuration and including a first surface for receiving light from a display matrix and a second surface for emitting light to the eye of the user. The prism of the optical layers 176A-N extends over all or at least a portion of the respective apertures 175 formed in the left and right rims 107 to permit the user to see the second surface of the prism when the eye of the user is viewing through the corresponding rims 107. The first surface of the prism of the optical layers 176A-N faces upwardly from the frame 105 and the display matrix 177 overlies the prism so that photons and light emitted by the display matrix 177 impinge the first surface. The prism is sized and shaped so that the light is refracted within the prism and is directed toward the eye of the user by the second surface of the prism of the optical layers 176A-N. In this regard, the second surface of the prism of the optical layers 176A-N can be convex to direct the light toward the center of the eye. The prism can optionally be sized and shaped to magnify the image projected by the display matrix 177, and the light travels through the prism so that the image viewed from the second surface is larger in one or more dimensions than the image emitted from the display matrix 177.

In one example, the optical layers 176A-N may include an LCD layer that is transparent (keeping the lens open) unless and until a voltage is applied which makes the layer opaque (closing or blocking the lens). The image processor 412 on the electronic eyewear device 100 may execute programming to apply the voltage to the LCD layer in order to produce an active shutter system, making the electronic eyewear device 100 suitable for viewing visual content when displayed as a 3D projection. Technologies other than LCD may be used for the active shutter mode, including other types of reactive layers that are responsive to a voltage or another type of input.

In another example, the image display device of optical assembly 180 has a display 182 that includes a projection image display as shown in FIG. 2B. Each optical assembly 180 includes a respective laser projector 150, such as a three-color laser projector using a scanning mirror or galvanometer. Each laser projector 150 is disposed in or on a respective temples 125 of the electronic eyewear device 100. Each optical assembly 180, in this example, includes one or more optical strips (shown as 155A-N in FIG. 2B), which are spaced apart and across the width of the lens of each optical assembly 180 or across a depth of the lens between the front surface and the rear surface of the lens.

As the photons projected by the laser projector 150 travel across the lens of each optical assembly 180, the photons encounter the optical strips 155A-N. When a particular photon encounters a particular optical strip, the photon is either redirected toward the user's eye, or it passes to the next optical strip. A combination of modulation of laser projector 150, and modulation of optical strips, control specific photons or beams of light. In an example, a processor controls optical strips 155A-N by initiating mechanical, acoustic, or electromagnetic signals. Although shown as having two optical assemblies 180, the electronic eyewear device 100 can include other arrangements, such as a single or three optical assemblies, or each optical assembly 180 may have different arrangements depending on the application or intended user of the electronic eyewear device 100.

FIG. 3 is a diagrammatic depiction of a 3D scene 306, a first raw image 302A captured by a first camera 114A, and a second raw image 302B captured by a second camera 114B. The first field of view 111A may overlap, as shown, with the second field of view 111B. The overlapping fields of view 304 represents that portion of the image captured by both cameras 114. The term ‘overlapping’ when referring to field of view means the matrix of pixels in the generated raw images overlap by thirty percent (30%) or more. ‘Substantially overlapping’ means the matrix of pixels in the generated raw images—or in the infrared image of scene—overlap by fifty percent (50%) or more. As described herein, the two raw images 302 may be processed to include a timestamp, which allows the images to be displayed together as part of a three-dimensional projection.

For the capture of stereo images, as illustrated in FIG. 3, a pair of raw red, green, and blue (RGB) images are captured of a 3D scene 306 at a given moment in time—a first raw image 302A captured by the first camera 114A and second raw image 302B captured by the second camera 114B. When the pair of raw images 302 are processed (e.g., by the image processor 412), depth images are generated. The generated depth images may be viewed on the optical assemblies 180 of an electronic eyewear device, on another display (e.g., the image display 580 on a mobile device 401), or on a screen.

The generated depth images are in the three-dimensional space domain and can comprise a matrix of vertices on a three-dimensional location coordinate system that includes an X axis for horizontal position (e.g., length), a Y axis for vertical position (e.g., height), and a Z axis for depth (e.g., distance). Each vertex may include a color attribute (e.g., a red pixel light value, a green pixel light value, or a blue pixel light value); a position attribute (e.g., an X location coordinate, a Y location coordinate, and a Z location coordinate); a texture attribute; a reflectance attribute; or a combination thereof. The texture attribute quantifies the perceived texture of the depth image, such as the spatial arrangement of color or intensities in a region of vertices of the depth image.

FIG. 4 is a functional block diagram of an example demonstration system 400 that includes an electronic eyewear device 100, a mobile device 401, and a server system 498 connected via various networks 495 such as the Internet. As shown, the demonstration system 400 includes a low-power wireless connection 425 and a high-speed wireless connection 437 between the electronic eyewear device 100 and the mobile device 401.

The electronic eyewear device 100 includes one or more cameras 114 that capture still images, video images, or both still and video images, as described herein. The cameras 114 may have a direct memory access (DMA) to high-speed circuitry 430 and function as a stereo camera. The cameras 114 may be used to capture initial-depth images that may be rendered into three-dimensional (3D) models that are texture-mapped images of a red, green, and blue (RGB) imaged scene. The device 100 may also include a depth sensor that uses infrared signals to estimate the position of objects relative to the device 100. The depth sensor in some examples includes one or more infrared emitter(s) and infrared camera(s) 410.

The electronic eyewear device 100 further includes two image displays of optical assemblies 180 (one associated with the right side 170A and one associated with the left side 170B). The electronic eyewear device 100 also includes an image display driver 442, an image processor 412, low-power circuitry 420, and high-speed circuitry 430. The image displays of optical assemblies 180 are for presenting images, including still images, video images, or still and video images. The image display driver 442 is coupled to the image displays of optical assemblies 180 in order to control the display of images.

The components shown in FIG. 4 for the electronic eyewear device 100 are located on one or more circuit boards, for example a printed circuit board (PCB) or flexible printed circuit (FPC), located in the rims or temples. Alternatively, or additionally, the depicted components can be located in the corners, frames, hinges, or bridge of the electronic eyewear device 100. The cameras 114 include digital camera elements such as a complementary metal-oxide-semiconductor (CMOS) image sensor, a charge-coupled device, a lens, or any other respective visible or light capturing elements that may be used to capture data, including still images or video of scenes with unknown objects.

As shown in FIG. 4, high-speed circuitry 430 includes a high-speed processor 432, a memory 434, and high-speed wireless circuitry 436. In the example, the image display driver 442 is coupled to the high-speed circuitry 430 and operated by the high-speed processor 432 in order to drive the image displays of optical assemblies 180. High-speed processor 432 may be essentially any processor capable of managing high-speed communications and operation of any general computing system. High-speed processor 432 includes processing resources needed for managing high-speed data transfers on high-speed wireless connection 437 to a wireless local area network (WLAN) using high-speed wireless circuitry 436.

In some examples, the high-speed processor 432 executes an operating system such as a LINUX operating system or other such operating system of the electronic eyewear device 100 and the operating system is stored in memory 434 for execution. In addition to any other responsibilities, the high-speed processor 432 executes a software architecture for the electronic eyewear device 100 that is used to manage data transfers with high-speed wireless circuitry 436. In some examples, high-speed wireless circuitry 436 is configured to implement Institute of Electrical and Electronic Engineers (IEEE) 802.11 communication standards, also referred to herein as Wi-Fi. In other examples, other high-speed communications standards may be implemented by high-speed wireless circuitry 436.

The low-power circuitry 420 includes a low-power processor 422 and low-power wireless circuitry 424. The low-power wireless circuitry 424 and the high-speed wireless circuitry 436 of the electronic eyewear device 100 can include short-range transceivers (Bluetooth™ or Bluetooth Low-Energy (BLE)) and wireless wide, local, or wide-area network transceivers (e.g., cellular or Wi-Fi). Mobile device 401, including the transceivers communicating via the low-power wireless connection 425 and the high-speed wireless connection 437, may be implemented using details of the architecture of the electronic eyewear device 100, as can other elements of the network 495.

Memory 434 includes any storage device capable of storing various data and applications, including, among other things, camera data generated by the cameras 114A, 114B, the infrared camera(s) 410, the image processor 412, and images generated for display by the image display driver 442 on the image display of each optical assembly 180. Although the memory 434 is shown as integrated with high-speed circuitry 430, the memory 434 in other examples may be an independent, standalone element of the electronic eyewear device 100. In some such examples, electrical routing lines may provide a connection through a chip that includes the high-speed processor 432 from the image processor 412 or low-power processor 422 to the memory 434. In other examples, the high-speed processor 432 may manage addressing of memory 434 such that the low-power processor 422 will boot the high-speed processor 432 any time that a read or write operation involving memory 434 is to be performed.

As shown in FIG. 4, various elements of the electronic eyewear device 100 can be coupled to the low-power circuitry 420, high-speed circuitry 430, or both. For example, the infrared camera 410 (including in some implementations an infrared emitter), the user input elements 491 (e.g., a button switch, a touchpad 181, a microphone 139), and the inertial measurement unit (IMU) 472 may be coupled to the low-power circuitry 420, high-speed circuitry 430, or both.

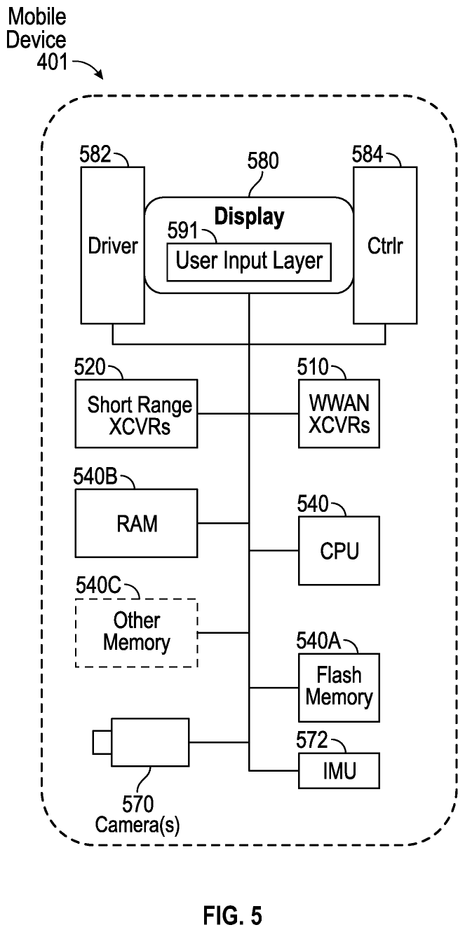

As shown in FIG. 5, which is discussed if further detail below, the CPU 540 of the mobile device 401 may be coupled to a camera system 570, a mobile display driver 582, a user input layer 591, and a memory 540A.

The server system 498 may be one or more computing devices as part of a service or network computing system, for example, that include a processor, a memory, and network communication interface to communicate over the network 495 with an electronic eyewear device 100 and a mobile device 401.

The output components of the electronic eyewear device 100 include visual elements, such as the image displays associated with each lens or optical assembly 180 as described with reference to FIGS. 2A and 2B (e.g., a display such as a liquid crystal display (LCD), a plasma display panel (PDP), a light emitting diode (LED) display, a projector, or a waveguide). The electronic eyewear device 100 may include a user-facing indicator (e.g., an LED, a speaker 191, or a vibrating actuator), or an outward-facing signal (e.g., an LED, a speaker 191). The image displays of each optical assembly 180 are driven by the image display driver 442. In some example configurations, the output components of the electronic eyewear device 100 further include additional indicators such as audible elements (e.g., speakers 191), tactile components (e.g., an actuator such as a vibratory motor to generate haptic feedback), and other signal generators. For example, the device 100 may include a user-facing set of indicators, and an outward-facing set of signals. The user-facing set of indicators are configured to be seen or otherwise sensed by the user of the device 100. For example, the device 100 may include an LED display positioned so the user can see it, one or more speakers 191 positioned to generate a sound the user can hear, or an actuator to provide haptic feedback the user can feel. The outward-facing set of signals are configured to be seen or otherwise sensed by an observer near the device 100. Similarly, the device 100 may include an LED, a speaker 191, or an actuator that is configured and positioned to be sensed by an observer.

The user input elements 491 of the electronic eyewear device 100 may include alphanumeric input components (e.g., a touch screen or touchpad 181 configured to receive alphanumeric input, a photo-optical keyboard, or other alphanumeric-configured elements), pointer-based input components (e.g., a mouse, a touchpad 181, a trackball, a joystick, a motion sensor, or other pointing instruments), tactile input components (e.g., a button switch, a touch screen or touchpad 181 that senses the location, force or location and force of touches or touch gestures, or other tactile-configured elements), and audio input components (e.g., a microphone 139), and the like. The mobile device 401 and the server system 498 may include alphanumeric, pointer-based, tactile, audio, and other input components.

In some examples, the electronic eyewear device 100 includes a collection of motion-sensing components referred to as an IMU 472. The motion-sensing components may be micro-electro-mechanical systems (MEMS) with microscopic moving parts, often small enough to be part of a microchip. The IMU 472 in some example configurations includes an accelerometer, a gyroscope, and a magnetometer. The accelerometer senses the linear acceleration of the device 100 (including the acceleration due to gravity) relative to three orthogonal axes (x, y, z). The gyroscope senses the angular velocity of the device 100 about three axes of rotation (pitch, roll, yaw). Together, the accelerometer and gyroscope can provide position, orientation, and motion data about the device relative to six axes (x, y, z, pitch, roll, yaw). The magnetometer, if present, senses the heading of the device 100 relative to magnetic north. The position of the device 100 may be determined by location sensors, such as a GPS unit, one or more transceivers to generate relative position coordinates, altitude sensors or barometers, and other orientation sensors. Such positioning system coordinates can also be received over the wireless connections 425, 437 from the mobile device 401 via the low-power wireless circuitry 424 or the high-speed wireless circuitry 436.

The IMU 472 may include or cooperate with a digital motion processor or programming that gathers the raw data from the components and compute a number of useful values about the position, orientation, and motion of the device 100. For example, the acceleration data gathered from the accelerometer can be integrated to obtain the velocity relative to each axis (x, y, z); and integrated again to obtain the position of the device 100 (in linear coordinates, x, y, and z). The angular velocity data from the gyroscope can be integrated to obtain the position of the device 100 (in spherical coordinates). The programming for computing these useful values may be stored in memory 434 and executed by the high-speed processor 432 of the electronic eyewear device 100.

The electronic eyewear device 100 may optionally include additional peripheral sensors, such as biometric sensors, specialty sensors, or display elements integrated with electronic eyewear device 100. For example, peripheral device elements may include any I/O components including output components, motion components, position components, or any other such elements described herein. For example, the biometric sensors may include components to detect expressions (e.g., hand expressions, facial expressions, vocal expressions, body gestures, or eye tracking), to measure bio signals (e.g., blood pressure, heart rate, body temperature, perspiration, or brain waves), or to identify a person (e.g., identification based on voice, retina, facial characteristics, fingerprints, or electrical bio signals such as electroencephalogram data), and the like.

The mobile device 401 may be a smartphone, tablet, laptop computer, access point, or any other such device capable of connecting with electronic eyewear device 100 using both a low-power wireless connection 425 and a high-speed wireless connection 437. Mobile device 401 is connected to server system 498 and network 495. The network 495 may include any combination of wired and wireless connections.

The demonstration system 400, as shown in FIG. 4, includes a computing device, such as mobile device 401, coupled to an electronic eyewear device 100 over a network 495. The demonstration system 400 includes a memory (e.g., a non-transitory computer readable media) for storing instructions and a processor for executing the instructions. In some implementations, the memory and processing functions of the demonstration system 400 can be shared or distributed across the processors and memories of the electronic eyewear device 100, the mobile device 401, and/or the server system 498.

In some implementations, the demonstration system 400 includes a demonstration application 910, a localization system 915, an image processing system 920, a voice recognition module 925, and an animation engine 930.

The demonstration application 910 in some implementations presents a primary avatar 710 and a secondary avatar 720 on the display 182, as described herein.

The localization system 915 in some implementations obtains localization data for use in determining the position of the electronic eyewear device 100 relative to the physical environment. For example, the localization system 915 may access the frames of motion data 902 captured by the IMU 472 to determine the electronic eyewear device location 840 in three-dimensional coordinates relative to the physical environment (with or without reference to data from other sources, such as still images or video data). As used herein, the term ‘frames of motion data’ refers to the motion data captured by the IMU 472, including motion data captured by any sensor component of the IMU in any form and at any sample rate. In this context, the term ‘frames’ refers to and is based on the characteristic that motion data is captured periodically and is not intended to be limiting. In some implementations, the localization data may be derived from a series of images captured by at least one camera 114A, from the frames of motion data 902 captured by the IMU 472, from data gathered by a GPS unit, or from a combination thereof.

The image processing system 920 in some implementations presents virtual or graphical elements (e.g., avatars, performing poses, as described herein) on a display of a respective optical assembly 180, in cooperation with the image display driver 442 and the image processor 412.

The voice recognition module 925 in some implementations receives human speech, converts the received speech into frames of audio data 905, identifies an inquiry or a request based on the audio data 905, and executes an action that is correlated with and responsive to the identified inquiry or request.

The animation engine 930 in some implementations renders avatars, as described herein, for presentation on a display 182. Predefined and configurable images and animations are accessible over the network 495 and, in some implementations, are stored in the activity library 480 described herein.

FIG. 5 is a high-level functional block diagram of an example mobile device 401. Mobile device 401 includes a flash memory 540A which stores programming to be executed by the CPU 540 to perform all or a subset of the functions described herein.

The mobile device 401 may include a camera 570 that comprises at least two cameras (e.g., first and second visible-light cameras with overlapping fields of view) or at least one camera and a depth sensor with substantially overlapping fields of view. Flash memory 540A may further include multiple images or video, which are generated via the camera 570.

As shown, the mobile device 401 includes an image display 580, a mobile display driver 582 to control the image display 580, and a display controller 584. In the example of FIG. 5, the image display 580 includes a user input layer 591 (e.g., a touchscreen) that is layered on top of or otherwise integrated into the screen used by the image display 580.

Examples of touchscreen-type mobile devices that may be used include (but are not limited to) a smart phone, a personal digital assistant (PDA), a tablet computer, a laptop computer, or other portable device. However, the structure and operation of the touchscreen-type devices is provided by way of example; the subject technology as described herein is not intended to be limited thereto. For purposes of this discussion, FIG. 5 therefore provides a block diagram illustration of the example mobile device 401 with a user interface that includes a touchscreen input layer 591 for receiving input (by touch, multi-touch, or gesture, and the like, by hand, stylus, or other tool) and an image display 580 for displaying content

As shown in FIG. 5, the mobile device 401 includes at least one digital transceiver (XCVR) 510, shown as WWAN XCVRs, for digital wireless communications via a wide-area wireless mobile communication network. The mobile device 401 also includes additional digital or analog transceivers, such as short-range transceivers (XCVRs) 520 for short-range network communication, such as via NFC, VLC, DECT, ZigBee, Bluetooth™, or Wi-Fi. For example, short range XCVRs 520 may take the form of any available two-way wireless local area network (WLAN) transceiver of a type that is compatible with one or more standard protocols of communication implemented in wireless local area networks, such as one of the Wi-Fi standards under IEEE 802.11.

To generate location coordinates for positioning of the mobile device 401, the mobile device 401 can include a global positioning system (GPS) receiver. Alternatively, or additionally the mobile device 401 can utilize either or both the short range XCVRs 520 and WWAN XCVRs 510 for generating location coordinates for positioning. For example, cellular network, Wi-Fi, or Bluetooth™ based positioning systems can generate accurate location coordinates, particularly when used in combination. Such location coordinates can be transmitted to the electronic eyewear device over one or more network connections via XCVRs 510, 520.

The mobile device 401 in some examples includes a collection of motion-sensing components referred to as an inertial measurement unit (IMU) 572 for sensing the position, orientation, and motion of the mobile device 401. The motion-sensing components may be micro-electro-mechanical systems (MEMS) with microscopic moving parts, often small enough to be part of a microchip. The inertial measurement unit (IMU) 572 in some example configurations includes an accelerometer, a gyroscope, and a magnetometer. The accelerometer senses the linear acceleration of the mobile device 401 (including the acceleration due to gravity) relative to three orthogonal axes (x, y, z). The gyroscope senses the angular velocity of the mobile device 401 about three axes of rotation (pitch, roll, yaw). Together, the accelerometer and gyroscope can provide position, orientation, and motion data about the device relative to six axes (x, y, z, pitch, roll, yaw). The magnetometer, if present, senses the heading of the mobile device 401 relative to magnetic north.

The IMU 572 may include or cooperate with a digital motion processor or programming that gathers the raw data from the components and compute a number of useful values about the position, orientation, and motion of the mobile device 401. For example, the acceleration data gathered from the accelerometer can be integrated to obtain the velocity relative to each axis (x, y, z); and integrated again to obtain the position of the mobile device 401 (in linear coordinates, x, y, and z). The angular velocity data from the gyroscope can be integrated to obtain the position of the mobile device 401 (in spherical coordinates). The programming for computing these useful values may be stored in on or more memory elements 540A, 540B, 540C and executed by the CPU 540 of the mobile device 401.

The transceivers 510, 520 (i.e., the network communication interface) conforms to one or more of the various digital wireless communication standards utilized by modern mobile networks. Examples of WWAN transceivers 510 include (but are not limited to) transceivers configured to operate in accordance with Code Division Multiple Access (CDMA) and 3rd Generation Partnership Project (3GPP) network technologies including, for example and without limitation, 3GPP type 2 (or 3GPP2) and LTE, at times referred to as “4G.” For example, the transceivers 510, 520 provide two-way wireless communication of information including digitized audio signals, still image and video signals, web page information for display as well as web-related inputs, and various types of mobile message communications to/from the mobile device 401.

The mobile device 401 further includes a microprocessor that functions as a central processing unit (CPU); shown as CPU 540 in FIG. 4. A processor is a circuit having elements structured and arranged to perform one or more processing functions, typically various data processing functions. Although discrete logic components could be used, the examples utilize components forming a programmable CPU. A microprocessor for example includes one or more integrated circuit (IC) chips incorporating the electronic elements to perform the functions of the CPU. The CPU 540, for example, may be based on any known or available microprocessor architecture, such as a Reduced Instruction Set Computing (RISC) using an ARM architecture, as commonly used today in mobile devices and other portable electronic devices. Of course, other arrangements of processor circuitry may be used to form the CPU 540 or processor hardware in smartphone, laptop computer, and tablet.

The CPU 540 serves as a programmable host controller for the mobile device 401 by configuring the mobile device 401 to perform various operations, for example, in accordance with instructions or programming executable by CPU 540. For example, such operations may include various general operations of the mobile device, as well as operations related to the programming for applications on the mobile device. Although a processor may be configured by use of hardwired logic, typical processors in mobile devices are general processing circuits configured by execution of programming.

The mobile device 401 includes a memory or storage system, for storing programming and data. In the example, the memory system may include a flash memory 540A, a random-access memory (RAM) 540B, and other memory components 540C, as needed. The RAM 540B serves as short-term storage for instructions and data being handled by the CPU 540, e.g., as a working data processing memory. The flash memory 540A typically provides longer-term storage.

Hence, in the example of mobile device 401, the flash memory 540A is used to store programming or instructions for execution by the CPU 540. Depending on the type of device, the mobile device 401 stores and runs a mobile operating system through which specific applications are executed. Examples of mobile operating systems include Google Android, Apple iOS (for iPhone or iPad devices), Windows Mobile, Amazon Fire OS, RIM BlackBerry OS, or the like.

The processor 432 within the electronic eyewear device 100 may construct a map of the environment surrounding the electronic eyewear device 100, determine a location of the electronic eyewear device within the map of the environment, and determine a relative position of the electronic eyewear device to one or more objects in the mapped environment. The processor 432 may construct the map and determine location and position information using a simultaneous localization and mapping (SLAM) algorithm applied to data received from one or more sensors. Sensor data includes images received from one or both of the cameras 114A, 114B, distance(s) received from a laser range finder, position information received from a GPS unit, motion and acceleration data received from an IMU 572, or a combination of data from such sensors, or from other sensors that provide data useful in determining positional information. In the context of augmented reality, a SLAM algorithm is used to construct and update a map of an environment, while simultaneously tracking and updating the location of a device (or a user) within the mapped environment. The mathematical solution can be approximated using various statistical methods, such as particle filters, Kalman filters, extended Kalman filters, and covariance intersection. In a system that includes a high-definition (HD) video camera that captures video at a high frame rate (e.g., thirty frames per second), the SLAM algorithm updates the map and the location of objects at least as frequently as the frame rate; in other words, calculating and updating the mapping and localization thirty times per second.

Sensor data includes image(s) received from one or both cameras 114A, 114B, distance(s) received from a laser range finder, position information received from a GPS unit, motion and acceleration data received from an IMU 472, or a combination of data from such sensors, or from other sensors that provide data useful in determining positional information.

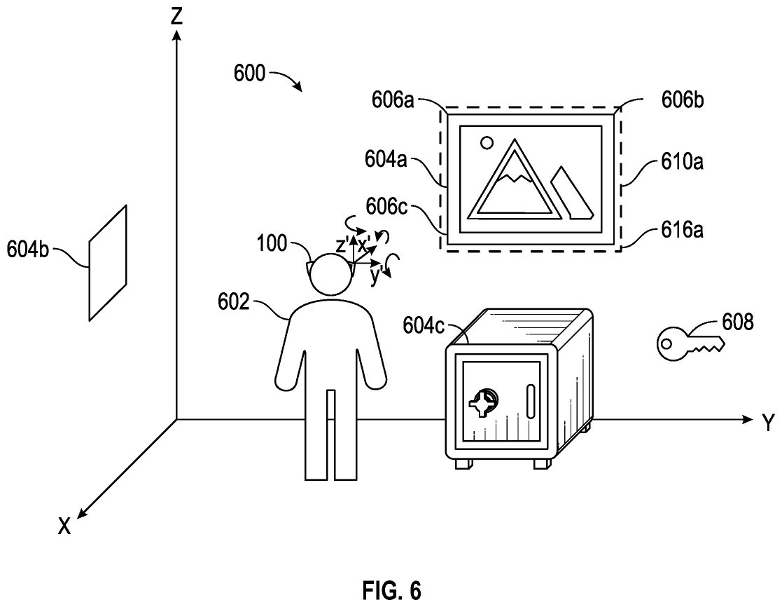

FIG. 6 depicts an example physical environment 600 along with elements that are useful when using a SLAM algorithm and other types of tracking applications (e.g., natural feature tracking (NFT), hand tracking, etc.). A user 602 of electronic eyewear device 100 is present in an example physical environment 600 (which, in FIG. 6, is an interior room). The processor 432 of the electronic eyewear device 100 determines the position of the eyewear device 100 with respect to one or more physical objects 604 within the environment 600 using captured image data, constructs a map of the environment 600 using a coordinate system (e.g., a Cartesian coordinate system (x, y, z)) for the environment 600, and determines the position relative to the coordinate system. Additionally, the processor 432 determines a head pose (roll, pitch, and yaw) of the electronic eyewear device 100 within the environment by using two or more location points (e.g., three location points 606a, 606b, and 606c) associated with a single object 604a, or by using one or more location points 606 associated with two or more objects 604a, 604b, 604c. The processor 432 of the electronic eyewear device 100 may position a virtual object 608 (such as the key shown in FIG. 6) within the environment 600 for viewing during an augmented reality experience.

The localization system 915 in some examples includes a virtual marker 610a associated with a virtual object 608 in the physical environment 600. In an augmented reality environment, in some implementations, markers are registered at locations in the physical environment 600 to assist electronic devices with the task of tracking and updating the location of users, devices, and objects (virtual and physical) relative to the physical environment. Markers are sometimes registered to a high-contrast physical object, such as the relatively dark object, such as the framed picture 604a, mounted on a lighter-colored wall, to assist cameras and other sensors with the task of detecting the marker. The markers may be assigned and registered in a memory by the electronic eyewear device 100 operating within the environment. In some implementations, the markers are assigned and registered in the memory of other devices in the network.

The localization system 915 tracks physical objects and virtual objects within the physical environment 600 relative to the electronic eyewear device 100. For a physical object 604 (e.g., safe 604c) the localization system 915 continuously analyzes captured images of the physical environment 600 to identify the object 604 and to determine its location relative to the electronic eyewear device 100 (e.g., by applying a SLAM algorithm). The localization system 915 maintains and updates the determined location information for the physical object 604 in memory, thereby tracking the physical object 604 as the electronic eyewear device 100 moves through the physical environment 600. For a virtual object 608 (e.g., key) the localization system 915 establishes or designates an initial location for the virtual object 608 corresponding to a location or a physical object 604 in the environment 600 (or, in some implementations, at a location relative to the electronic eyewear device 100). The localization system 915 maintains and updates the virtual object 608 location information, for example, in accordance with a movement (e.g., bouncing, rotating, flashing) associated with the virtual object 608, in response to movement of the electronic eyewear device 100 through the environment, or a combination thereof, thereby tracking the virtual object 608 as the electronic eyewear device 100 moves through the environment.

Markers can be encoded with or otherwise linked to information. A marker might include position information, a physical code (such as a bar code or a QR code; either visible to the user or hidden), or a combination thereof. A set of data associated with the marker is stored in the memory 434 of the electronic eyewear device 100. The set of data includes information about the marker 610a, the marker's position (location and orientation), one or more virtual objects, or a combination thereof. The marker position may include three-dimensional coordinates for one or more marker landmarks 616a, such as the corner of the generally rectangular marker 610a shown in FIG. 6. The marker location may be expressed relative to real-world geographic coordinates, a system of marker coordinates, a position of the electronic eyewear device 100, or other coordinate system. The one or more virtual objects associated with the marker 610a may include any of a variety of materials, including still images, video, audio, tactile feedback, executable applications, interactive user interfaces and experiences, and combinations or sequences of such material. Any type of content capable of being stored in a memory and retrieved when the marker 610a is encountered or associated with an assigned marker may be classified as a virtual object in this context. The virtual key 608 shown in FIG. 6, for example, is a virtual object displayed as a still image, either 2D or 3D, at a marker location.

In one example, the marker 610a may be registered in memory as being located near and associated with a physical object 604a (e.g., the framed work of art shown in FIG. 6). In another example, the marker may be registered in memory as being a particular position with respect to the electronic eyewear device 100.

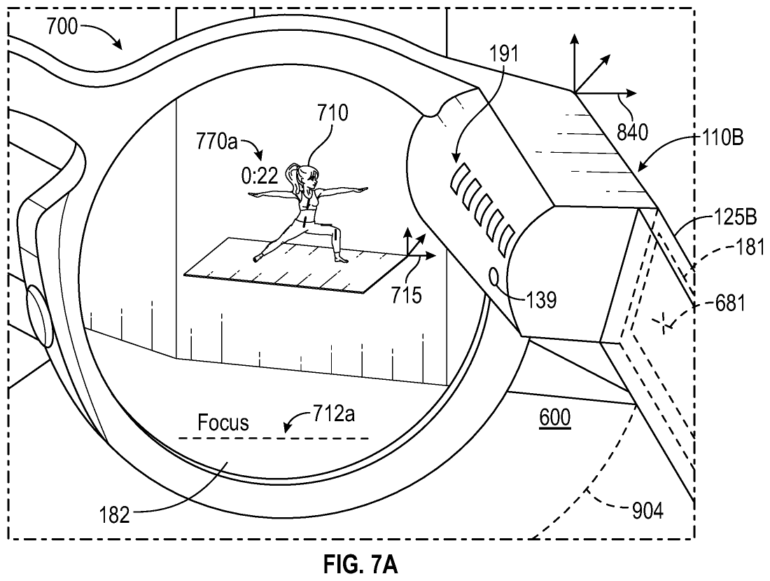

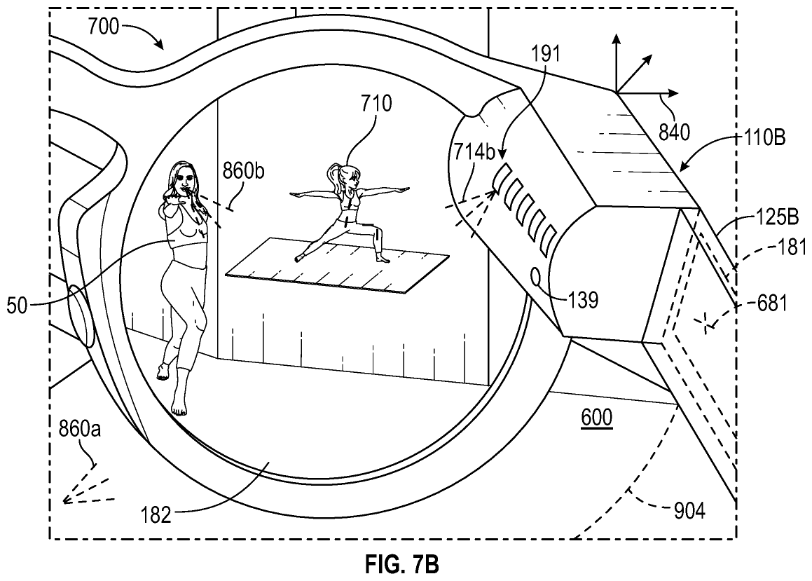

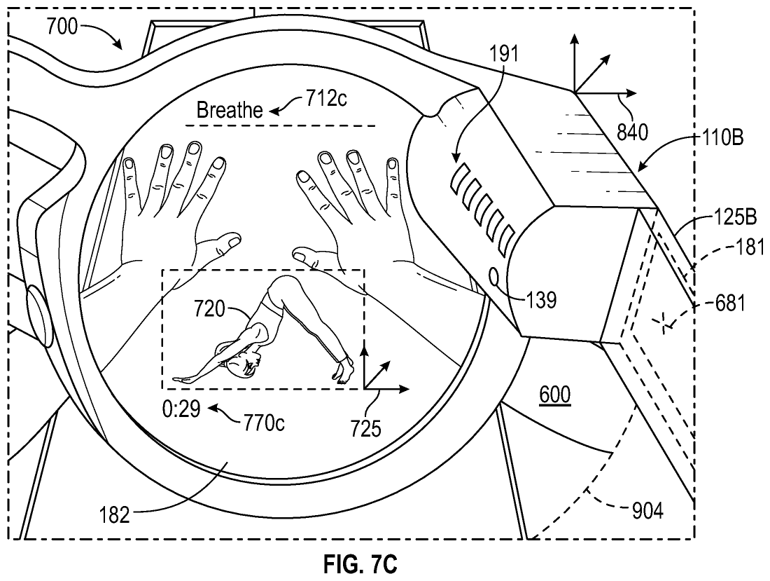

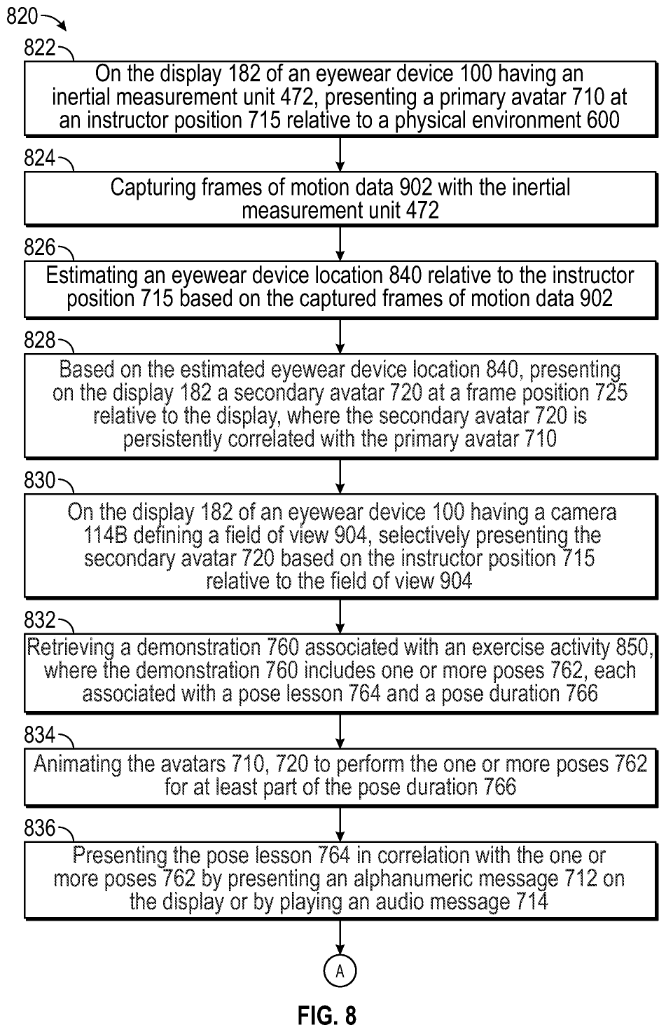

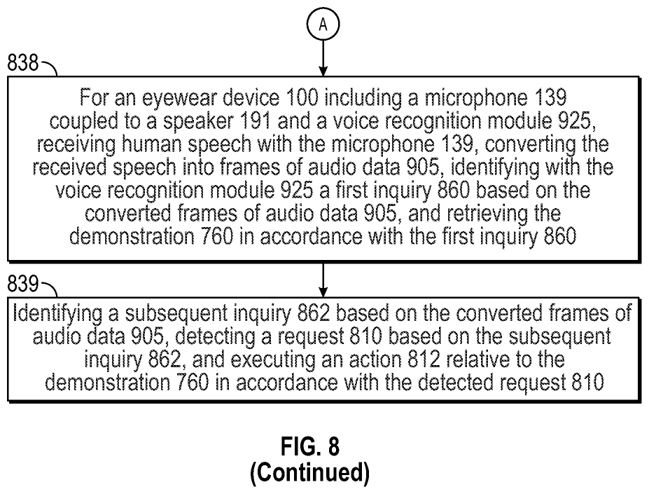

FIGS. 7A, 7B, and 7C are perspective illustrations of example virtual tutorials 700 in which one or more avatars are presented the display 182 of an electronic eyewear device 100. The processes of generating, presenting, and controlling a virtual tutorial 700 are described in detail in the discussion of the flow chart 820 shown in FIG. 8.

FIG. 8 is a flow chart 820 of an example method of presenting a virtual tutorial 700 on the display 182 of an electronic eyewear device 100. Although the steps are described with reference to the electronic eyewear device 100 described herein, other implementations of the steps described, for other types of devices, will be understood by one of skill in the art from the description herein. One or more of the steps shown and described may be performed simultaneously, in a series, in an order other than shown and described, or in conjunction with additional steps. Some steps may be omitted or, in some applications, repeated.

The demonstration application 910 described herein, in some implementations, starts in response to receiving a selection through a user interface (e.g., selecting from a menu, pressing a button, using a touchpad) or through some other input means (e.g., hand gesture, motion of a finger touch 681 on the touch pad 181, voice command).

Block 822 in FIG. 8 describes an example step of presenting a primary avatar 710 on the display 182 of an electronic eyewear device 100. The electronic eyewear device 100 in this example includes a display 182 and an IMU 472. The primary avatar 710 is presented at an instructor position 715 relative to the physical environment 600. The instructor position 715 in some implementations is generally fixed so that it appears at the same position relative to the surrounding physical environment 600, without regard to the display 182 or the motion of the electronic eyewear device 100 through the physical environment 600. The primary avatar 710 is presented on the display 182 as an overlay relative to the physical environment 600. As used herein, the term avatar means and includes a graphical representation of a character or person, such as an instructor, rendered or presented as either a still image or a moving image.

FIG. 7A is a perspective illustration of an example virtual tutorial 700 in which the primary avatar 710 is presented the display 182 at an instructor position 715 relative to the physical environment 600. The instructor position 715 means and refers to the position on the display 182 (e.g., near the top center of the display 182) where the primary avatar 710 is located. The instructor position 715 in some implementations is generally fixed relative to the physical environment 600 such that, after the primary avatar 710 is presented at the instructor position 715, the primary avatar 710 appears in generally the same location in the physical environment 600, regardless of the location of the electronic eyewear device 100. As shown, the primary avatar 710 in some implementations includes a time counter 770a (e.g., maintained by a processor of the electronic eyewear device 100) and an alphanumeric message 712a (e.g., a predefined message retrieved by the processor of the electronic eyewear device 100 from memory), which is part of a demonstration or a pose lesson, as described herein. The generally fixed instructor position 715 may be located, for example, in the front of a classroom or studio where a live instructor 50 (FIG. 7B) might stand to lead a group activity or class. In some implementations, as shown in FIG. 7B, the live instructor 50 is present in the physical environment 600 who may or may not be actively engaged in the activity. While the primary avatar 710 is presented at the instructor position 715, the live instructor 50 is free to move around the physical environment 600. In this aspect, the primary avatar 710 may be engaged in leading the class, providing demonstrations and lessons from a fixed instructor position 715, whereas the live instructor 50 is free to move round the room to other locations and for other purposes (e.g., to observe a student more closely, to offer verbal cues and direction to a student) in conjunction with the demonstration being performed by the primary avatar 710. The live instructor 50 may offer verbal instructions without interrupting the demonstration, or use a voice command, as described herein, to pause the demonstration while instructions are offered.

In a related aspect, as shown in FIG. 7B, a live instructor 50 may be performing a demonstration in a location or an orientation which is difficult to see or does not provide much in the way of instructive content. For example, the details and alignments for the example Warrior Two yoga pose performed by the live instructor 50 in FIG. 7B are relatively difficult to see, compared to the side view of the pose performed by the primary avatar 710, which shows more detail about the posture and alignment of the body. Moreover, as shown, the primary avatar 710 may include alignment cues, such as the dotted lines shown along the body of the primary avatar 710.

Block 824 describes an example step of capturing frames of motion data 902 with the IMU 472 of an electronic eyewear device 100. In some implementations, the process of capturing frames of motion data 902 is ongoing during active use of the electronic eyewear device 100. In other examples, the process of capturing starts in response to receiving a selection through a user interface or through some other input means. The example method, at block 824, in some implementations, includes storing the captured frames of motion data 902 in memory 434 on the electronic eyewear device 100, at least temporarily, such that the frames of motion data 902 are available for analysis.

Block 826 describes an example step of estimating the electronic eyewear device location 840 relative to the instructor position 715 (e.g., where the primary avatar 710 is presented). After the process of presenting the primary avatar 710 at the instructor position 715, the electronic eyewear device 100, of course, moves through the physical environment 600 and changes its location relative to the instructor position 715. The current electronic eyewear device location 840 in some implementations is estimated using the localization system 915 as described herein (e.g., in paragraphs 83-84, 103-04).

The localization system 915 on the electronic eyewear device 100 in some implementations configures the processor 432 of the electronic eyewear device 100 to obtain localization data based on the captured frames of motion data 902 gathered by the IMU 472. In some implementations, the localization system 915 constructs a virtual map of various elements within the camera field of view 904 using a SLAM algorithm, as described herein, updating the map and the location of objects at least as frequently as the IMU 472 captures motion data. In some implementations, the IMU 472 is capable of capturing motion data at high sample rates (e.g., 100 hertz (samples per second), 720 Hz, 1024 Hz, 1344 Hz, 3200 Hz, or higher). Frequent measurements facilitate the detection and analysis of relatively subtle motions of the electronic eyewear device 100 over time, relative to the primary avatar 710 and the instructor position 715.

The step of estimating the electronic eyewear device location 840 relative to the instructor position 715 in some implementations includes calculating a correlation between the instructor position 715 and the current electronic eyewear device location 840. The term correlation refers to and includes one or more vectors, matrices, formulas, or other mathematical expressions sufficient to define the three-dimensional distance between the instructor position 715 and the current electronic eyewear device location 840. The current electronic eyewear device location 840 is coupled to the three-dimensional position and orientation (e.g., head pose, gaze direction) of the display 182 because the display 182 is supported by the frame of the electronic eyewear device 100. In this aspect, the process of correlation performs the function of calibrating the motion of the electronic eyewear device 100 with the instructor position 715. Because the localization process occurs continually, the process of correlation between the eyewear device location 840 and the instructor position 715 produces accurate and near real-time tracking of the current electronic eyewear device location 840 relative to the instructor position 715.

In some implementations, the process of estimating the current electronic eyewear device location 840 is based on the frames of motion data 902 captured by the IMU 472, or on the frames of video data 900 captured by a camera 114A coupled to the electronic eyewear device 100, or a combination of both. The process of estimating the current electronic eyewear device location 840 in some implementations is executed about as frequently as the IMU 472 captures motion data (e.g., one hundred times per second, based on an IMU sample rate of 100 Hz (samples per second)). In some implementations, the process of estimating the current electronic eyewear device location 840 occurs at a predefined and configurable frequency, and the IMU 472 is configured to captured frames of motion data 902 at a compatible rate.

Block 828 describes an example step of presenting a secondary avatar 720 on the display 182 based on the current electronic eyewear device location 840. The secondary avatar 720 is presented at a frame position 725 relative to the display 182. The frame position 725 in some implementations is generally fixed so that it appears at the same position on the display 182, without regard to the surrounding physical environment 600 or the motion of the electronic eyewear device 100 through the environment. The frame position 725 in some implementations includes a frame or window surrounding the secondary avatar 720, as shown in FIG. 7C. The secondary avatar 720 is presented as an overlay relative to the physical environment 600.

The secondary avatar 720 in some implementations is persistently correlated with the primary avatar 710, such that both avatars 710, 720 are performing the same or similar demonstration and lessons, as described herein. As used herein, the term “persistently correlated” refers to and means that the avatars 710, 720 are almost always performing the same or similar demonstration (e.g., exhibiting the same or similar pose), by and through the same or similar type of avatar (e.g., a fully-rendered three-dimensional character as the primary avatar 710 and a corresponding two-dimensional stick figure as the secondary avatar 720), on a nearly continual basis (e.g., almost always correlated in time and generally without interruption or deviation).

FIG. 7C is a perspective illustration of an example virtual tutorial 700 in which the secondary avatar 720 is presented at a frame position 725 relative to the display 182. As shown in this example, the student in FIG. 7C is generally in a face-down posture with his hands on a yoga mat. The primary avatar 710 (as presented at the instructor position 715) would not be visible through the display 182 while the student is in this face-down posture. In this aspect, the secondary avatar 720 provides the same or similar demonstration and lessons, as described herein, when the primary avatar 710 may or may not be visible to the student. In some implementations the primary avatar 710 is not presented or disabled when the secondary avatar 720 is presented; in others, both avatars 710, 720 are presented all or most of the time.

The student's apparent ability to see the primary avatar 710, in this example step, can be estimated based on the current electronic eyewear device location 840. For example, if the current electronic eyewear device location 840 suggests the student is facing away from the primary avatar 710, the demonstration system 400 is configured to determine that the primary avatar 710 is likely not viewable from the perspective of the wearer or student. The current electronic eyewear device location 840 includes, in three dimensions, information about both the position (e.g., location in the room) and the orientation (e.g., facing forward, left or right, up or down) of the electronic eyewear device 100. For example, the orientation data from the electronic eyewear device location 840 will indicate that the student wearing the electronic eyewear device 100 is in a generally face-down posture, as shown in FIG. 7C. In response to this electronic eyewear device location 840, the secondary avatar 720 is presented at the frame position 725 on the display 182.

The student's apparent ability to see the primary avatar 710, in some implementations, is based on the position and orientation of the electronic eyewear device 100 (in other words, the direction the wearer is facing) as well as the field of view 904 of a camera 114A on the electronic eyewear device 100. In some implementations, the electronic eyewear device 100 stores the captured frames of video data 900 with at least one camera 114A as the wearer moves through a physical environment 600. As described herein and shown in FIG. 7C, the camera 114A in some implementations has a camera field of view 904 that captures images and video beyond the limits of the display 182 (in other words, the captured images and video are larger than the size and shape of the display 182 on the optical assembly 180 of the eyewear). The camera system, in some implementations, includes one or more high-resolution, digital cameras equipped with a CMOS image sensor capable of capturing high-definition still images and high-definition video at relatively high frame rates (e.g., thirty frames per second or more). Each frame of digital video includes depth information for a plurality of pixels in the image. In this aspect, the camera system serves as a high-definition scanner by capturing a detailed input image of the physical environment. The camera in some implementations includes a pair of high-resolution digital cameras 114A, 114B coupled to the electronic eyewear device 100 and spaced apart to acquire a left-camera raw image and a right-camera raw image, as described herein. When combined, the raw images form an input image that includes a matrix of three-dimensional pixel locations. The example method, at block 830, in some implementations, includes storing the captured frames of video data 900 in memory 434 on the electronic eyewear device 100, at least temporarily, such that the frames are available for analysis.

Block 830 describes an example step of selectively presenting the secondary avatar 720 based on the instructor position 715 (of the primary avatar 710) relative to the field of view 904 of the camera 114B. In this context, the term selectively means the secondary avatar 720 is presented under certain conditions, such as when the system determines that the primary avatar 710 is likely not viewable by the student or wearer of the electronic eyewear device 100. In this example, if the location and orientation of the electronic eyewear device 100 is not directed toward the instructor position 715 (e.g., the wearer is looking elsewhere) or the instructor position 715 is otherwise outside the field of view 904 (e.g., indicated that the primary avatar 710 is not readily viewable through the display 182), then the system selectively presents the secondary avatar 720 on the display 182. The presentation is selective in that the secondary avatar 720 is only presented when (and, in some implementations, only for as long as) an evaluation of the field of view 904 suggests that the primary avatar 710 is not readily viewable through the display 182. In this aspect, the current status of the field of view 904 is determined by the current eyewear device location 840 (e.g., both the position and the orientation of the eyewear device 100). For example, if the current eyewear device location 840 indicates that the electronic eyewear device 100 is directed toward the floor, as shown in FIG. 7C, then the field of view 904 will include a view of the floor. The primary avatar 710 is presented on the display 182 at the instructor position 715 (e.g., at the front of the room or studio). If the field of view 904 does not include the instructor position 715, the primary avatar 710 is likely not viewable, and the system will present the secondary avatar 720 on the display 182 at the frame position 725 (e.g., near the center of the display 182, as shown in FIG. 7C). In this example, the secondary avatar 720 is selectively presented when the field of view 904 does not includes the primary avatar 710.

Block 832 describes an example step of retrieving a demonstration 760 associated with an exercise activity 850. Block 834 describes an example step of animating the avatars 710, 720 to perform the demonstration 760.

Predefined and configurable demonstrations 760 in some implementations are accessible over the network 495 or are stored in the activity library 480 described herein. The demonstration 760 is associated with a particular exercise activity 850, such as yoga, Pilates, calisthenics, isometrics, aerobics, weightlifting, swimming, and running. The exercise activity 850 in some implementation includes any activity in which proper posture is desired, including activities like golf, martial arts, gymnastics, diving, physical therapy, ballet, and dance.

The demonstration 760 in some implementations comprises one or more poses 762, each associated with a pose lesson 764 and a pose duration 766. In the context of demonstrations, the term “pose” refers to and includes an avatar (e.g., a stick figure, line drawing, or 3D character) demonstrating the proper or desired body postures related to an exercise or activity, such as yoga, calisthenics, golf, physical therapy, or dance. A pose 762 may be a single still image or an animated three-dimensional demonstration. An exercise activity 850, from golf to ballet, can be analyzed in terms of a series or sequence of poses. A pose lesson 764 may be provided with one or more of the poses 762 during the demonstration 760. The term ‘pose lesson’ as used herein refers to and includes one or more guidelines or instructions associated with a particular pose, presented for example as an alphanumeric message, an audio message, an audio-visual presentation, or a combination thereof.

In the example context of yoga, a demonstration 760 for a yoga class typically includes a series of poses 762, each associated with a pose lesson 764 and lasting for a suggested pose duration 766 (e.g., a first pose lasts thirty seconds). The process in some implementations includes presenting a time counter 770 associated with the pose duration 766, in any of a variety of timing, graphics, and formats (e.g., elapsed time, countdown). For example, FIG. 7A shows a counter 770a presented near the primary avatar 710. FIG. 7C shows a counter 770c presented near the secondary avatar 720. The time counter 770c (e.g., counting down from thirty seconds to zero) in this example is associated with a desired or suggested pose duration 766 (e.g., thirty seconds) for a particular pose 762 (e.g., downward-facing dog).

Block 834 describes an example step of animating the avatars 710, 720 to perform the demonstration 760. The process of animating in some implementations is controlled and driven by an animation engine 930 in cooperation with the image display driver 442 and an image processor 412 of the electronic eyewear device 100. Predefined and configurable avatars, in some implementations, are accessible over the network 495 or may be retrieved from the activity library 480 described herein. As used herein, the term animating means and includes rendering or otherwise preparing an avatar for presentation on a display. The term avatar means and includes any of a variety of representational figures, from simple line drawings or stick figures to complex, interactive, three-dimensional characters. The example process of animating is discussed with reference to the primary avatar 710 and applies equally to the secondary avatar 720. The process of animating the secondary avatar 720 in some implementations involves the same or similar techniques as animating the primary avatar 710 because, as described herein, the secondary avatar 720 is persistently correlated with the primary avatar 710.

The example process of animating the primary avatar 710 in some implementations includes animating the primary avatar 710 to perform the one or more poses 762 of the demonstration 760 for at least part of the pose duration 766 associated with each pose. For a particular demonstration 760, the poses 762 may be generally static (e.g., holding a yoga pose, addressing the ball in golf) or actively dynamic (e.g., flexion/extension of the knee, jumping rope). Many demonstrations 760 include particular movements during the transition between poses 762 (e.g., moving between ballet positions, moving from one yoga pose to the next). In this aspect, a pose 762 in some implementations includes the poses and postures performed across an entire activity or exercise, including movements that might be described as transitions. In some implementations, a transition itself is defined as a separate and distinct pose 762, having its own associated pose lesson 764 and pose duration 766.

Block 836 describes an example step of presenting a pose lesson 764 in correlation with one or more poses 762. The pose lesson 764 in some implementations is presented on the display 182 at or near the beginning of the presentation of the associated pose 762, at any particular time during the pose 762, or for the enter pose duration 766. For example, a pose lesson 764 may begin with a starting message and include intermediate messages presented at pre-defined moments during the pose 762.

The pose lesson 764 in some implementations includes an alphanumeric message 712 or an audio message 714, or both. For example, FIG. 7A shows an alphanumeric message 712a presented on the display 182 in association with the primary avatar 710. FIG. 7C shows an alphanumeric message 712c presented in association with the secondary avatar 720. An alphanumeric message 712 may be presented on the display 182 at any of a variety of locations. In some implementations, the alphanumeric message 712 is presented on the display 182 according to the space available relative to other elements (e.g., a time counter 770, an avatar 710 or 720). In some implementations, the alphanumeric message 712 is presented on the display 182 according to an expected head position or gaze direction, as informed by the current electronic eyewear device location 840.

The pose lesson 764 in some implementations includes an audio message 714, by itself or in conjunction with an alphanumeric message. The audio message 714 in some implementations is played through a speaker in the physical environment 600 or through a speaker 191 that is part of or coupled to the electronic eyewear device 100. For example, FIG. 7B shows an audio message 714b played through the speaker 191 of the electronic eyewear device 100.

Block 838 describes an example step of using voice commands to retrieve and otherwise activate a demonstration 760. The electronic eyewear device 100 in some implementations includes a voice recognition module 925, as described herein, and a microphone 139 coupled to a speaker 191. The voice recognition module 925 in some implementations configures the processor 432 to perceive human speech, convert the received speech into frames of audio data 905, identify a first inquiry 860 based on converted frames of audio data 905, and perform an action in response to and in accordance with the identified first inquiry 860. For example, the human speech may include a verbal command (e.g., “Start morning yoga,” “Get shoulder rotation therapy routine”) and the identified first inquiry 860 causes the demonstration application 910 to retrieve a demonstration 760 from a resource over the network 495 or from the activity library 480 described herein.

The detected speech may originate from any person or source (e.g., a recording) within a detecting proximity of the microphone 139. For example, FIG. 7B shows a first example inquiry 860a that originates from a student (e.g., wearing the electronic eyewear device 100) and another example inquiry 860b that originates from a live instructor 50 located in the physical environment 600 and near the microphone 139. In this aspect, either the student or the instructor 50 can speak a voice command as part of the process of retrieving and otherwise activating a demonstration 760. In some implementations, a live instructor 50 is wearing his or her own electronic eyewear device which is configured to present all or part of the demonstration 760 in near real time, as the same demonstration 760 is being broadcast wirelessly and presented to one or more students on their eyewear devices. In this example implementation, the live instructor 50 can speak a voice command to retrieve and activate a demonstration 760 (e.g., as described at block 832), monitor the progress of the demonstration 760 on his or her display, observe the poses 762 and pose lessons 764, offer additional or different instructions based on experience or training (e.g., in a speech directed toward the students), and otherwise participate in the experience with the students.

Block 839 describes an example step of executing an action 812 in response to a subsequent inquiry 862. In this example process, the voice recognition module 925 identifies a subsequent inquiry 862 based on converted frames of audio data 905, detects a request 810 based on the subsequent inquiry 862, and execute an action 812 relative to the demonstration 760 in accordance with the detected request 810.

The action 812 in some implementations is applied to any part or segment of a demonstration 760, including one or more of the poses 762, pose lesson 764 (e.g., text, audio), and pose durations 766. For example, a subsequent inquiry 862 (e.g., “Show that again”) and the detected request 810 (e.g., Repeat) processed during a particular pose (e.g., Warrior Three in yoga) may result in a corresponding action 812 (e.g., repeating the demonstration 760 associated with the particular pose). In some implementations, the subsequent inquiry 862 and the detected request 810 include progress control commands (e.g., play, pause, resume, repeat, stop, skip, go back) and the resulting action 812 allows the user to control the progress of the demonstration 760.

Similar to the first inquiry 860, the subsequent inquiry 862 may originate from any source or person (e.g., student or instructor 50) within a detecting proximity of the microphone 139. In this aspect, either the student or the instructor can utter a voice command as part of the process of controlling the process of a demonstration 760. For example, a live instructor 50 might observe a student and determine that she would benefit from hearing a pose lesson 764 or repeating a particular pose. The live instructor 50, of course, may offer verbal instructions apart from or in addition to the virtual demonstration 760. In this aspect, the demonstration 760 and a live instructor 50 may cooperate to deliver a tutorial.

Although the various systems and methods are described herein with reference to pose-specific exercises and activities such as yoga, the technology described may be applied to demonstrating the proper performance of any of a variety of experiences and activities involving motion in a physical environment.

Any of the functionality described herein for the electronic eyewear device 100, the mobile device 401, and the server system 498 can be embodied in one or more computer software applications or sets of programming instructions, as described herein. According to some examples, “function,” “functions,” “application,” “applications,” “instruction,” “instructions,” or “programming” are program(s) that execute functions defined in the programs. Various programming languages can be employed to develop one or more of the applications, structured in a variety of manners, such as object-oriented programming languages (e.g., Objective-C, Java, or C++) or procedural programming languages (e.g., C or assembly language). In a specific example, a third-party application (e.g., an application developed using the ANDROID™ or IOS™ software development kit (SDK) by an entity other than the vendor of the particular platform) may include mobile software running on a mobile operating system such as IOS™, ANDROID™, WINDOWS® Phone, or another mobile operating system. In this example, the third-party application can invoke API calls provided by the operating system to facilitate functionality described herein.

Hence, a machine-readable medium may take many forms of tangible/non-transitory storage medium. Non-volatile storage media include, for example, optical or magnetic disks, such as any of the storage devices in any computer devices or the like, such as may be used to implement the client device, media gateway, transcoder, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer may read programming code or data. Many of these forms of computer readable media may be involved in carrying one or more sequences of one or more instructions/program code to a processor for execution.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” “includes,” “including,” or any other variation thereof, are intended to cover a non-exclusive inclusion, such that a process, method, article, or apparatus that comprises or includes a list of elements or steps does not include only those elements or steps but may include other elements or steps not expressly listed or inherent to such process, method, article, or apparatus. An element preceded by “a” or “an” does not, without further constraints, preclude the existence of additional identical elements in the process, method, article, or apparatus that comprises the element.

Unless otherwise stated, any and all measurements, values, ratings, positions, magnitudes, sizes, and other specifications that are set forth in this specification, including in the claims that follow, are approximate, not exact. Such amounts are intended to have a reasonable range that is consistent with the functions to which they relate and with what is customary in the art to which they pertain. For example, unless expressly stated otherwise, a parameter value or the like may vary by as much as plus or minus ten percent from the stated amount or range.

In addition, in the foregoing Detailed Description, it can be seen that various features are grouped together in various examples for the purpose of streamlining the disclosure. This method of disclosure is not to be interpreted as reflecting an intention that the claimed examples require more features than are expressly recited in each claim. Rather, as the following claims reflect, the subject matter to be protected lies in less than all features of any single disclosed example. Thus, the following claims are hereby incorporated into the Detailed Description, with each claim standing on its own as a separately claimed subject matter.

While the foregoing has described what are considered to be the best mode and other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present concepts.

What is claimed is:

1. A method of presenting a virtual tutorial an electronic eyewear device in a physical environment, the electronic eyewear device comprising a processor, an inertial measurement unit, and a display, the method comprising the steps of:
generating, by the processor, a primary avatar for presentation on the display at an instructor position relative to the physical environment;
receiving, by the processor, frames of motion data captured by the inertial measurement unit;
estimating an electronic eyewear device location relative to the instructor position based on the received frames of motion data; and
generating, based on the estimated electronic eyewear device location, a secondary avatar for presentation on the display at a frame position relative to the display, wherein the secondary avatar is persistently correlated with the primary avatar.

2. The method of claim 1, wherein the electronic eyewear device further comprises a camera defining a field of view, and
wherein the step of generating the secondary avatar further comprises selectively generating the secondary avatar for presentation based on the instructor position relative to the field of view.

3. The method of claim 1, wherein the electronic eyewear device further comprises a camera, the method further comprising the steps of:
receiving frames of video data captured by the camera; and
estimating the electronic eyewear device location relative to the instructor position based on the received frames of video data.

4. The method of claim 1, wherein the step of generating the primary avatar further comprises generating a primary animation comprising the primary avatar performing a demonstration, and
wherein the step of generating the secondary avatar further comprises generating a secondary animation comprising the secondary avatar performing the demonstration.

5. The method of claim 1, further comprising the step of:
retrieving a demonstration associated with an exercise activity, wherein the demonstration comprises one or more poses, each associated with a pose lesson and a pose duration,
wherein at least one of the steps of generating the primary avatar or generating the secondary avatar further comprises the steps of:
generating at least one of a primary animation of the primary avatar or a secondary animation of the secondary avatar comprising a performance of the one or more poses for at least a part of the pose duration;
generating a time counter associated with the pose duration for presentation on the display adjacent the frame position; and
generating the pose lesson in correlation with the one or more poses, wherein the step of generating the pose lesson comprises one or more operations selected from the group consisting of generating an alphanumeric message for presentation on the display and generating an audio message for transmission through a speaker.

6. The method of claim 5, wherein the electronic eyewear device further comprises a microphone coupled to a speaker and a voice recognition module, and wherein the step of retrieving the demonstration further comprises the steps of:
receiving speech with the microphone;
converting the received speech into frames of audio data;
identifying, with the voice recognition module, a first inquiry based on the converted frames of audio data; and
retrieving, by the processor, the demonstration in accordance with the first inquiry.

7. The method of claim 6, wherein the step of retrieving the demonstration further comprises the steps of:
identifying a subsequent inquiry based on the converted frames of audio data;
detecting a request based on the subsequent inquiry, wherein the request comprises one or more control commands selected from the group consisting of play, pause, resume, repeat, skip, and stop; and
executing an action relative to the demonstration in accordance with the detected request.

8. The method of claim 7, wherein at least one of the first inquiry or the subsequent inquiry originates from a live instructor.

9. An electronic eyewear device for presenting a virtual exercise tutorial, comprising:
a processor;
a memory;
an inertial measurement unit;
a display; and
programming in the memory, wherein execution of the programming by the processor configures the electronic eyewear device to perform functions, including functions to:
generate a primary avatar for presentation on the display at an instructor position relative to a physical environment;
receive frames of motion data captured by the inertial measurement unit;
estimate an electronic eyewear device location relative to the instructor position based on the received frames of motion data; and
generate, based on the estimated electronic eyewear device location, a secondary avatar for presentation on the display at a frame position relative to the electronic eyewear device, wherein the secondary avatar is persistently correlated with the primary avatar.

10. The electronic eyewear device of claim 9, wherein the electronic eyewear device further comprises a camera defining a field of view, and
wherein the function to generate the secondary avatar further comprises a function to selectively generate the secondary avatar for presentation based on the instructor position relative to the field of view.

11. The electronic eyewear device of claim 9, wherein the electronic eyewear device further comprises a camera defining a field of view, and wherein the execution of the programming further configures the electronic eyewear device to perform functions to:
receive frames of video data captured by the camera; and
estimate the electronic eyewear device location relative to the instructor position based on the received frames of video data.

12. The electronic eyewear device of claim 9, wherein the function to generate the secondary avatar further comprises a function to generate a primary amination comprising the primary avatar performing a demonstration, and
wherein the function to generate the secondary avatar further comprises a function to generate a secondary amination comprising the secondary avatar performing the demonstration.

13. The electronic eyewear device of claim 9, wherein the execution of the programming further configures the electronic eyewear device to perform functions to:
retrieve a demonstration associated with an exercise activity, wherein the demonstration comprises one or more poses, each associated with a pose lesson and a pose duration,
wherein at least one of the functions to generate the primary avatar or generate the secondary avatar further comprises functions to:
generate at least one of a primary animation of the primary avatar or a secondary animation of the secondary avatar comprising a performance of the one or more poses for at least a part of the pose duration;
generate a time counter associated with the pose duration for presentation on the display adjacent the frame position; and
generate the pose lesson in correlation with each of the one or more poses, wherein the function to generate comprises one or more operations selected from the group consisting of generating an alphanumeric message on the display and generating an audio message for transmission through a speaker.

14. The electronic eyewear device of claim 13, wherein the electronic eyewear device further comprises a microphone coupled to a speaker and a voice recognition module, and wherein the function to retrieve the demonstration further comprises functions to:
receive speech with the microphone;
convert the received speech into frames of audio data;
identify, with the voice recognition module, a first inquiry based on the converted frames of audio data; and
retrieve the demonstration in accordance with the first inquiry.

15. The electronic eyewear device of claim 14, wherein the function to retrieve the demonstration further comprises functions to:
identify a subsequent inquiry based on the converted frames of audio data;
detect a request based on the subsequent inquiry, wherein the request comprises one or more control commands selected from the group consisting of play, pause, resume, repeat, skip, and stop; and
execute an action relative to the pose lesson in accordance with the detected request.

16. The electronic eyewear device of claim 15, wherein at least one of the first inquiry or the subsequent inquiry originates from a live instructor.

17. A non-transitory computer-readable medium storing program code that, when executed, is operative to cause a processor of an electronic eyewear device to perform the steps of:
receiving frames of motion data captured by an inertial measurement unit coupled to the electronic eyewear device, the electronic eyewear device further comprising a camera and a display;
generating a primary avatar for presentation on the display at an instructor position relative to a physical environment;
estimating an electronic eyewear device location relative to the instructor position based on the received frames of motion data; and
generating, based on the estimated electronic eyewear device location, a secondary avatar for presentation on the display at a frame position relative to the electronic eyewear device, wherein the secondary avatar is persistently correlated with the primary avatar.

18. The non-transitory computer-readable medium storing program code of claim 17, wherein the program code when executed is operative to cause the processor to perform the further step of:
selectively generate the secondary avatar based on the instructor position relative to a field of view defined by the camera.

19. The non-transitory computer-readable medium storing program code of claim 17, wherein the program code, when executed, causes the processor to perform the further steps of:
retrieving a demonstration associated with an exercise activity, wherein the demonstration comprises one or more poses, each associated with a pose lesson and a pose duration,
generating at least one of a primary animation of the primary avatar or a secondary animation of the secondary avatar comprising a performance of the one or more poses for at least a part of the pose duration;
generating a time counter associated with the pose duration for presentation on the display adjacent the frame position; and
generating the pose lesson in correlation with each of the one or more poses, wherein the pose lesson comprises at least one of an alphanumeric message or an audio message.

20. The non-transitory computer-readable medium storing program code of claim 17, wherein the electronic eyewear device further comprises a microphone coupled to a speaker and a voice recognition module, and wherein the program code when executed is operative to cause the processor to perform the further steps of:
receiving frames of audio data based on speech captured by the microphone;
identifying, with the voice recognition module, an inquiry based on the received frames of audio data; and
retrieving a demonstration in accordance with the inquiry.
